(19) United States
(12) Patent Application Publication
(10) Pub. No.: US 2017/0293842 A1
(43) Pub. Date: Oct. 12, 2017

(54) Method And System For Unsupervised Learning Of Document Classifiers

(71) Applicant: i2k Connect, LLC., Missouri City, TX (US)

(72) Inventors: Bruce G. Buchanan, Orcas, WA (US); Reid G. Smith, Missouri City, TX (US); Eric J. Schoen, Bellaire, TX (US); Joshua R. Eckroth, Deland, FL (US)

(21) Appl. No.: 15/479,788

(22) Filed: Apr. 5, 2017

Related U.S. Application Data
(60) Provisional application No. 62/319,646, filed on Apr. 7, 2016.

(51) Int. Cl. G06N 5/02; G06F 17/30

(52) U.S. Cl. CPC G06N 5/022; G06F 17/30675

(57) ABSTRACT

A system and method for classifying unstructured text documents, without the need for pre-classified training examples. In general, the system and method provides for blending statistical, syntactic and semantic considerations to learn classifiers from an organization's unclassified internal and external unstructured text documents, as well as unclassified documents available via the Internet. In one form, for each class in a taxonomy the class name is expanded into semantically related words and phrases to build approximate classifiers. Each approximate classifier will almost certainly be erroneous but it can be used to identify an approximately correct set of documents. The process is recursive; e.g. the approximate classifier with the strongest evidence, is fed back into the system until a stale set of the strongest terms for each classifier has been selected.

### PRIORITY CLAIM

The present application claims priority to U.S. Provisional Application No. 62/319,646 filed Apr. 7, 2016, which is incorporated by reference herein.

### BACKGROUND

### 1. Field of the Invention

The present invention relates to systems and methods for classifying text documents, without the need for pre-classified training examples. In particular, the present invention provides a system and method for blending statistical, syntactic, and semantic considerations to learn classifiers from an organization's unclassified internal and external unstructured text documents, as well as unclassified documents available via the Internet.

### 2. Description of the Related Art

The growth of data relevant to an organization has been well documented. Such data are both internal and external to the organization and are included in unstructured text, as well as structured databases. One estimate is that 90 percent of all data on the internet are unstructured, see, Srinivasan, Venkat. “How AI is enabling the intelligent enterprise” VentureBeat (2017). http://venturebeat.com/2017/01/18/how-ai-is-enabling-the-intelligent-enterprise/January 18, 2017. With such a large amount of unstructured data, finding, filtering and analyzing information is both a massive and an immediate problem.

A primary precondition for finding and making use of unstructured text is that the data must be associated with index terms derived from classification or other tagging. Manual classification is possible for small amounts of unstructured data, but it is slow, inconsistent, and time-consuming. Given the dramatic growth in the volume of relevant data, many software methods have been developed to automatically classify the unstructured data, including purely statistical methods. Typically, such software methods use large numbers of pre-classified training examples to learn classifiers that apply to the unstructured text in both existing, unseen, and new documents. However, it is quite often not feasible to acquire large numbers of pre-classified training examples, because of the effort and cost involved.

Even when there are large enough numbers of pre-classified training examples available for statistical methods to work, they yield “black box” classifiers whose rationale cannot be explained. Yet, in many applications, explanations are regarded as essential. For example, starting in 2018, EU citizens will be entitled by law to know how institutions have arrived at decisions affecting them, even decisions made by machine-learning systems. See, Thompson, Clive. “Sure, A.I. Is Powerful—But Can We Make It Accountable?” Wired Magazine (2016). https://www.wired.com/2016/10/understanding-artificial-intelligence-decisions/Nov. 27, 2016. Thus the task of creating transparent decision-making programs that can provide justifications for their decisions is an immediate concern.

Various approaches have been made to automate the classification of data. For example, U.S. Pat. Nos. 8,335,753; 8,719,257; 8,880,392; and 8,874,549. (Incorporated by reference.)

### SUMMARY

The problems outlined above for classifying unstructured text documents are addressed by the systems and methods described herein for blending statistical, syntactic, and semantic considerations to learn classifiers from an organization's unclassified internal and external unstructured documents, as well as unclassified documents available via the Internet. Generally, the present system and methods hereof include a computational procedure for learning rules for classifying text documents, without the need for pre-classified training examples.

In one embodiment, for each class in a taxonomic hierarchy, the class name is expanded into a set of semantically related terms; e.g., words and phrases. These related words and phrases are used as keywords in a straightforward keyword search to identify documents constituting an approximate ground truth (“AGT”) set of documents that are likely—but not guaranteed—to be included among examples of the class. Terms that are statistically, syntactically, and semantically prominent in this approximate set of documents are identified and put into rules to build approximate classifiers. A recursive procedure is then followed to apply the approximate classifiers, evaluate their performance, and refine the terms used until a stable set of the strongest terms has been selected.

After the procedure is complete, each approximate classifier is a set of rules in which a small number of errors will be discounted by the preponderance of evidence for the correct classifications.

When a justification for a classification is requested, the rules learned by the present system are used to highlight and list the relevant facts in the text of the document. Questions about the appropriateness of any classification are thus reduced to questions of whether specific rules do, indeed, provide evidence for a class assignment in specific factual contexts.

In one embodiment, a method of classifying a set of unstructured text documents for a subject matter without using pre-classified training examples is presented that first identifies a taxonomy of classes having class names for the subject matter. The set of text documents is searched with one or more of the class names or terms derived from the class names to construct an approximate classifier. The approximate classifier is used to classify at least some of the set of text documents into classes and produces a confidence factor for each document classified. The method generates a list of plausible terms for a number of the classes based at least in part on said confidence factor and eliminates plausible terms from the list for each class based at least in part on a set of elimination criteria. The approximate classifier is modified for each class based on the elimination criteria; and the process of classifying documents using the approximate classifier and modifying the approximate classifier repeated until a stopping condition is met.

### BRIEF DESCRIPTION OF THE DRAWINGS

FIG. 1 is a block diagram outlining the General Procedure and highlighting the two major components, the Initialization Procedure and the Recursive Procedure;

FIG. 2 is a flow chart of the Initialization Procedure in accordance with the current invention;

FIG. 3 is a block diagram of a subprocess of FIG. 2 to Create an Approximate Classifier de novo;

FIG. 4 is a flow chart of the Recursive Procedure in accordance with the present invention; and

FIG. 5 is an example of using the learned classifiers to classify a text document for purposes of providing news alerts.

### DESCRIPTION OF PREFERRED EMBODIMENTS

### I. Overview

A primary goal of the method is to classify unstructured textual documents without the need for pre-classified training examples. The procedure is recursive in the sense that the same steps are applied to a successively more refined approximate classifier as many times as needed to meet the stopping criteria.

The general idea is to learn a classifier for every class in a specified taxonomy using the following steps.

Initialization Procedure (Steps A-D):

A. Specify Taxonomy

B. Identify Corpus of Documents

C. Process Document Text

D. Construct Approximate Classifier

Recursive Procedure (Steps E-J):

E. Classify Documents with Approximate Classifier

F. Generate List of Plausible Terms

G. Eliminate Terms that are Syntactically, Semantically, or Statistically unlikely

H. Expand Remaining Terms into Grammatical and Semantic Variations

I. Update Approximate Classifier with Rules Using New Terms

J. Repeat steps (E)-(I) until Stopping Criteria are Met

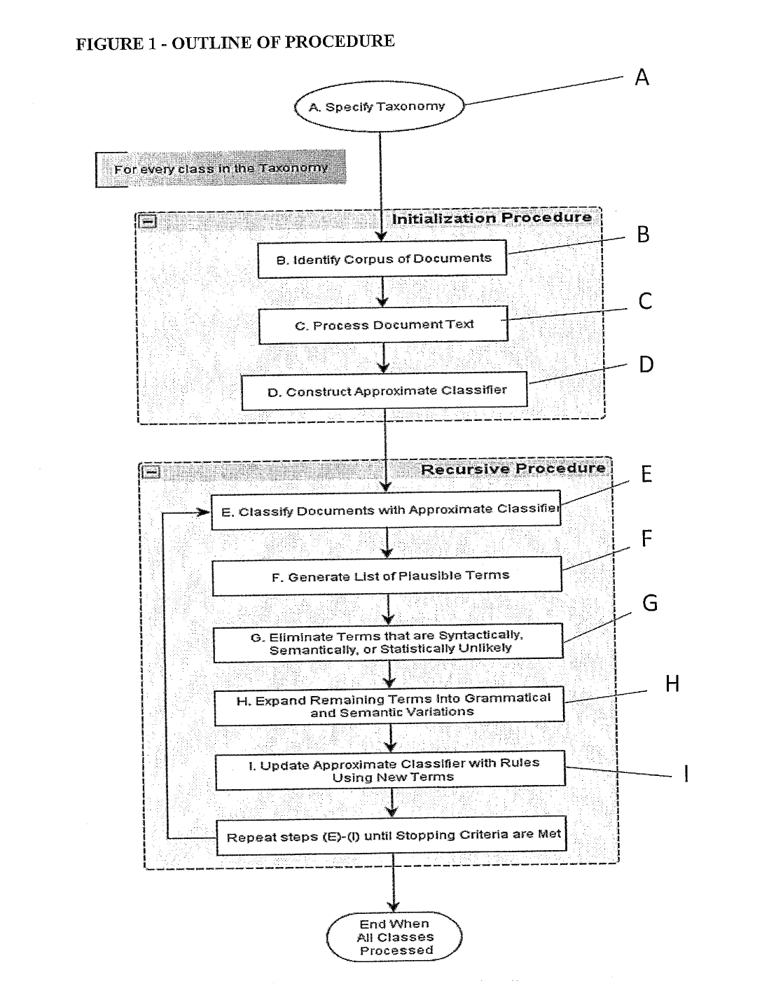

Repeat the Initialization and Recursive Procedure for every class in the taxonomy. FIG. 1 depicts the Initialization Procedure and the Recursive Procedure diagrammatically.

### II. Explanation of Terms

As used herein, the “Taxonomy” or “Input” to the procedure is a hierarchy of classes for a subject matter, or “domain”. Each class is represented as a path from general to specific classes. The precise representation is immaterial but “>” is used herein to indicate a class-subclass relationship.

Example: in the domain of petroleum exploration and production, one class of interest is “Reservoir Description and Dynamics>Fluids Characterization>Fluid Modeling, Equations of State.” Hence “Fluid Modeling, Equations of State” is a child of “Fluids Characterization”, which is a child of “Reservoir Description and Dynamics.”

“Leaf Node” refers to the most specific sub-class in a complete class name, “Fluid Modeling, Equations of State”, in the above example.

A “document” is an object to be classified based on its contents and any other available metadata. In the present applications of the procedure, electronically-stored documents, typically text documents (e.g., PDF files, MS Word files, web pages, email messages) are the objects and their contents are sequences of characters and words.

Documents that are tentatively classified into a class by an approximate classifier are referred to as the “Approximate Ground Truth” set, or “AGT”.

“Corpus” refers to a set of documents from which to learn terms. It can be any set of documents relevant to the domain from any source (e.g., the Internet, an Intranet, a file share, a Content Management System, an email repository).

The documents are initially “unstructured” in the sense that there are few, if any, known features that have known values, as might be found in a spreadsheet or database.

“Term” refers to either a multi-word sequence (“n-gram”), extracted or derived from document text, with optional punctuation, or a regular expression formed according to a standard grammar of regular expressions.

“Output” refers to a set of terms for use by a rule-based classifier to classify documents into the taxonomy.

The rules of the classifier have this basic form: If term T with class mapping C is found in document D, then accumulate evidence that document D is associated with class C.

### III. Details of Preferred Embodiments

For each class in the specified taxonomy, the initialization and the recursive procedures are executed to produce a classifier for every class. Details are provided below and in the appendices.

### Initialization

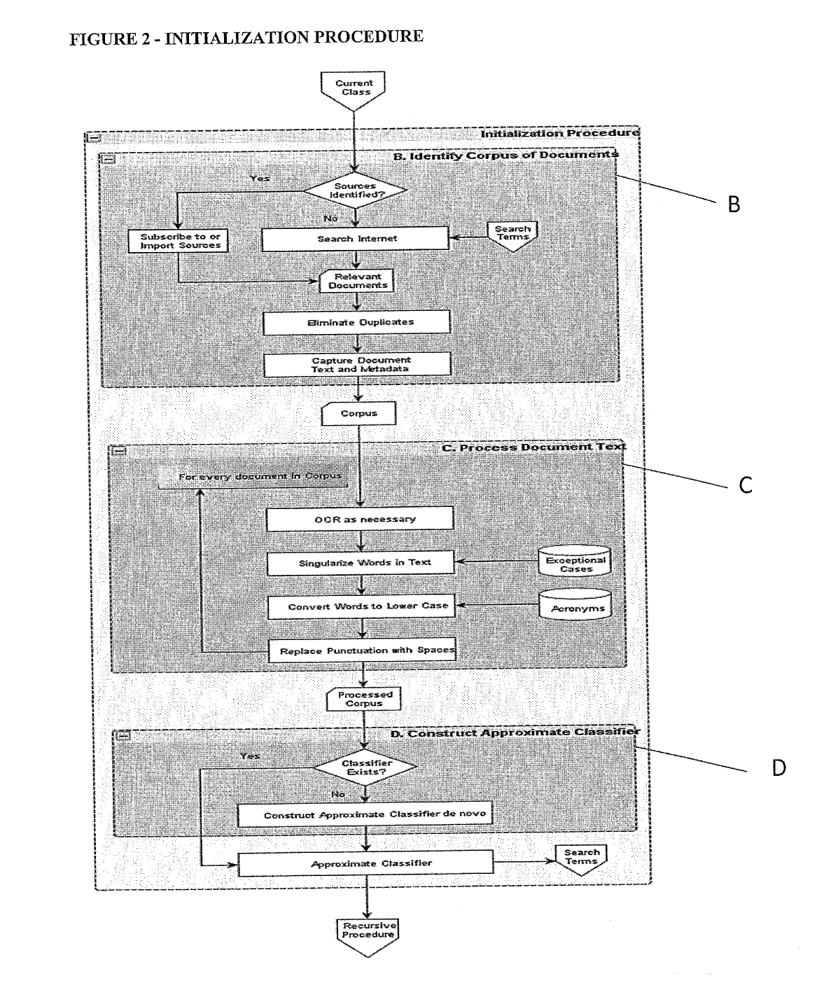

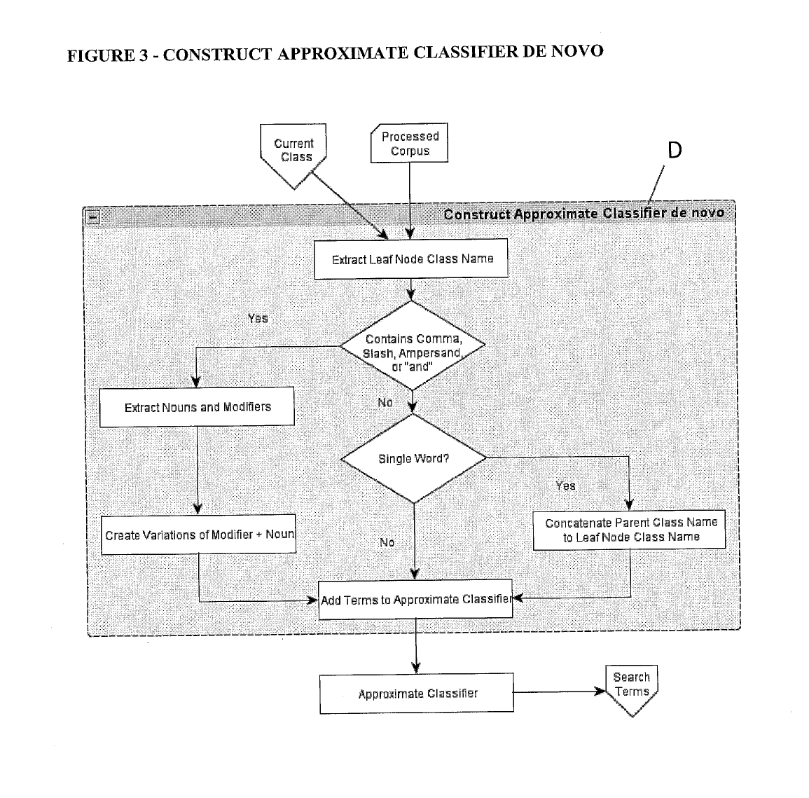

### See FIGS. 2 and 3.

### A. Specify Taxonomy

For a given subject matter domain, a hierarchical taxonomy of classes must be made available. The taxonomy may be pre-existing in the literature or custom-built. In either case, the taxonomy becomes the input into which objects are to be classified. See, Specify Taxonomy A in FIG. 1.

The procedure hereof requires the taxonomy class names to be words or phrases that can be found in documents or that have specified relationships to the contents of documents. The procedure will not work for class names that are arbitrary strings of alphanumeric characters that are unrelated to documents being classified. For example, in the domain of petroleum engineering, “fluid dynamics” is related to the domain but “x4z@” is not.

### B. Identify Corpus of Documents

The corpus is a set of documents from which to learn terms. The details of the Corpus Identification Procedure are described in Appendix A. The first step in the Initialization Procedure of FIG. 1 is to Identify Corpus of Documents B.

### C. Process Document Text

Because a corpus will almost certainly contain documents in several different text formats and styles, it is important to establish conventions for standardizing them. The details of the Process Document Text procedure C (FIG. 1) are described in Appendix B. The Process Document Text procedure C turns the content of each document into a sequence of words.

### D. Construct Approximate Classifier

If a classifier already exists for a class (e.g., constructed previously by the current embodiment or by a subject matter expert), it is used as the initial classifier. This increases the efficiency, but not the conceptual flow of the procedure.

If a classifier does not exist, the Construct Approximate Classifier procedure D (FIG. 1 is invoked. The Construct Approximate Classifier procedure D is described in Appendix C (Construct an Approximate Classifier de novo) and Appendix G (Linguistic Transformation Procedure) and used to construct an approximate classifier de novo from class names. The essence of the de novo construction procedure is to use the name of a class, along with syntactic and semantic variations on that name as rules for a classifier for the class. The intent at this stage is to produce a small list of high-confidence terms.

Details of the Construct Approximate Classifier procedure D is illustrated in more detail in FIG. 3.

### Recursive Procedure

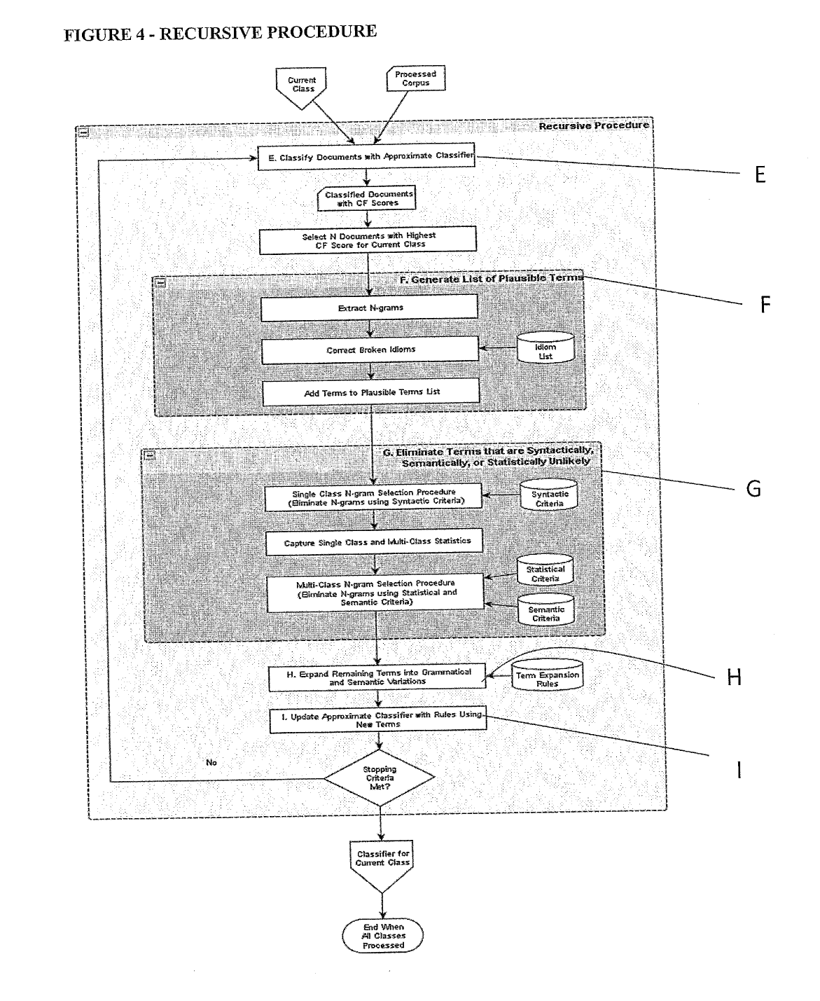

After the Initialization Procedure, the Recursive Procedure is invoked. See FIGS. 1 and 4.

E. Classify Documents with Approximate Classifier

The first step of the Recursive Procedure is to Classify Documents with Approximate Classifier E as seen in FIGS. 1 and 4. The purpose of the Classify Documents E step is to identify a subset of the documents for which there is some, possibly erroneous, evidence that they are exemplars of the class.

For each document in the Corpus, classify the document into the taxonomy. The classification process also produces a confidence factor for each classification it determines.

The classification system uses the rules in the Approximate Classifier, together with the location of terms (e.g., title, summary, filepath) and a hierarchical evidence gathering and scoring function. The output is one or more classifications and a confidence factor for each. The confidence factor is the normalized degree of certainty in the classification. It ranges from 0.0 to 1.0. For example, each time the precondition of a rule matches the input text, the system accumulates a small amount of evidence for the rule's classification. This evidence is amplified for matches in the title, summary and filepath. The system also takes into account the diversity of the matched rules. It assigns higher confidence to classifications that result to matches from multiple rules vs. multiple matches from a single rule. Finally, the system propagates evidence up the taxonomy hierarchy. Thus, if a match occurs for a rule associated with a sub-sub-class, evidence is also accumulated up the hierarchy to the associated sub-class and class.

For each class, select the N documents that have the highest confidence factors. This is the approximate ground truth (or “AGT”) set for the class. Missing some actual exemplars of the class at this stage is not as harmful as including only somewhat likely exemplars.

If N documents cannot be found, a subject matter expert is engaged to add to the sources from the Corpus Identification Procedure of Appendix A.

In the case where an initial set of AGT documents (e.g., web pages pre-classified into a company's products & services taxonomy) is supplied, they are imported in this step on the first iteration.

### F. Generate List of Plausible Terms

The work of the Generate List F step is to use n-gram analysis, described in Appendix D, to extract the words and phrases found in the text documents that could be used in additional rules for the classifier being constructed. The analysis produces a very large list of possible terms. The list is refined to include only the most plausible terms in Step G.

G. Eliminate Terms that are Syntactically, Semantically, or Statistically unlikely

The Eliminate Terms step G first applies the elimination criteria described in Appendix E (Single Class N-gram Selection Procedure) to remove candidate terms that are unlikely to contribute to successful classification of documents, regardless of the class with which they are associated. This removes terms that are grammatically odd or are unlikely to be associated very precisely with any class; e.g., terms whose last word is a preposition, or terms that are only numbers.

The Eliminate Terms step G then applies the selection criteria described in Appendix F (Multi-Class N-gram Selection Procedure). These criteria select terms whose statistics indicate they will contribute to successful classification rules, effectively removing terms whose statistics indicate lack of precision in distinguishing the AGT documents as a whole from the remainder of the corpus.

H. Expand Remaining Terms into Grammatical and Semantic Variations

The Expand Remaining Terms step H uses the Linguistic Transformation procedure described in Appendix G to apply a set of linguistic transformations to each term in the remaining set of terms. This expands the set of rules for the classifier being constructed.

I. Update Approximate Classifier with Rules Using New Terms

The Update Approximate Classifier I step is a simple replacement of the current Approximate Classifier. Once the replacement is made at the end of an iteration, the recursive procedure can be run again using the new version of the Approximate Classifier.

J. Repeat steps (E)-(I) Until Stopping Criteria are Met

As shown in FIG. 4, the steps E-I are recursive and run until a stopping condition is met. The stopping condition stops the refinement when the process converges; i.e., when one of the following criteria is met:
1. The difference in the number of plausible terms resulting from consecutive iterations of the procedure is smaller than a pre-set threshold; i.e., fewer than S terms are added or removed in successive iterations.
2. The same K or more terms are being added in one iteration and removed in another.
3. A classifier has been created for every class in the Taxonomy.

S and K are parameters that are determined experimentally.

In the case where an initial set of pre-classified AGT documents is supplied, agreement with the supplied classifications may be set as necessary pre-condition for stopping the procedure.

### IV. Examples of Use

Two examples are useful for illustrating the operation of the system and methods hereof in two different contexts. The classifiers learned by the methods described herein have been reviewed and augmented by a subject matter expert, with substantially less investment of the expert's time than with traditional learning methods. Over 52,000 rules are used to classify documents into 416 classes. The classes are organized in the SPE taxonomy in a three-level hierarchy starting with seven major classes.

1. Classifying News

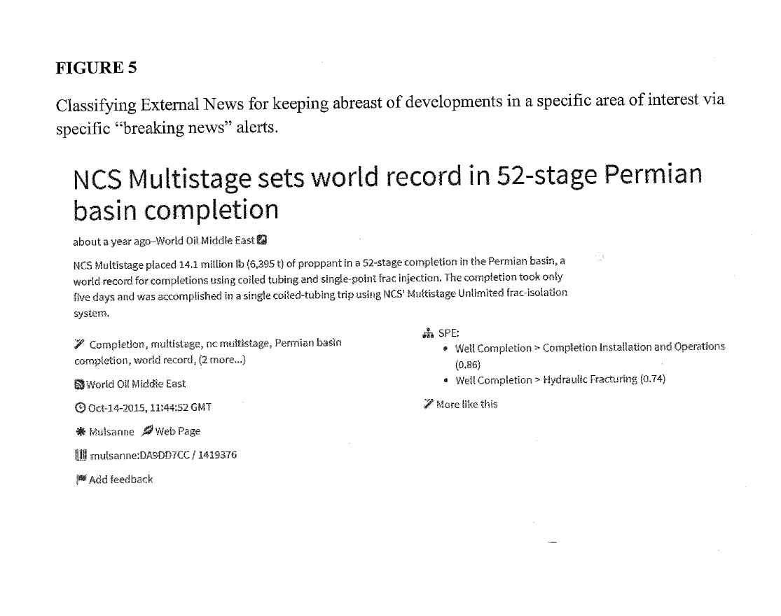

The example illustrated in FIG. 5 relates to classifying news for keeping abreast of developments in a specific area of interest. The figure shows the display of one article about hydraulic fracturing among many that have been published within the last year. The classifications are shown in the lower right under the name “SPE”, which is the taxonomy specified by the Society of Petroleum Engineers. The time range for so-called “breaking news” will normally be restricted to one day, and will include news stories published every few minutes. Additional information about each article that is displayed is not germane to the procedure described herein

1. Classifying Documents in a Collection

The SPE example illustrated below relates to classifying documents from a collection of more than 98,000 articles from conferences and journals of the Society of Petroleum Engineers. The SPE example below is a display of one of the articles to illustrate that each article may be classified into multiple taxonomies, each of which has been learned by the method herein.

The classifications include four classes of the 416 classes for the SPE taxonomy, from a classifier that was learned by the method described herein. For the article displayed, the article has been classified in the Industry taxonomy into the Energy sector, with further classification into “Oil & Gas”, and then into “Upstream” (i.e., upstream of the refinery). In the Oilfield Places taxonomy, the article has been classified into geographical regions and further into specific geological basins and oil fields. In the SPE taxonomy, which includes detail about petroleum engineering technical disciplines, the article is classified into two subclasses under “Well Completion” and two under “Management and Information”. As with the previous example, other information about each article is displayed but is not germane to the procedure described herein.

SPE Example:

While hydraulic fracturing is perhaps the most widely used well completion technique for production or injeciton enhancement, often treatments are badly or inadequately designed and/or executed. Because fracture treatments are performed in fields which contain hundreds of wells, large databases are generated de facto. These databases contain considerable and valuable information, but they are rarely used by engineers for the purpose of improving or optimizing future treatments or to select the most promising refracturing candidates. There are two main reasons, which prevent such obvious use; lack of time and, especially, lack of appropriate tools.

There are, however, emerging methodologies, which can be applied for this exercise and they fall under the general catergory of Data Mining and Knowledge Discovery. Although these terms are already established, the specific tool used in the mehtod and case study presented in this paper is new and innovative.

The method uses Self Organizing Maps (SOMs) which are used to group (cluster) high dimensional data. Clustering data can be done with multidimensional cross plots to a certain extent, but when a large amount of parameters (dimensions) is necessary, the cross plot loses its effectiveness and coherence.

The technique, as shown also in the case study of this paper, first identifies underperforming wells in relation to others in a given field. SOMs have been employed in this work to cluster different fracture input parameters (proppant volume, fluid volume, net pay thickness, etc.) of about 200 fracture treatments into different groups. To differentiate between these groups, the incremental post fracture treatment production has been used as an output. The comparision of the different clusters with the corresponding output reveals a better practice for future treatments and possible refracture candidates. It is improartnt to mote that the output has been included in the clusting process itself.

Once the wells are identified, a Neutral Network is trained to rank the most promising wells for a refracture treatment and new optimum fracture design are prepared which compare ideal performance with the one observed. These are then the criterion for deciding refracturing candidates as well as a signifant aid in the design of treatments in new wells in the neighborhood.

This work and methodology that it implies provide for a faster and more efficient way to analyze well performance data and, thus, to reach a verdict on the success or failure of past treatements. The technique leads to the definitive selection of refracturing candidates and to the improvement of future designs.

### V. Appendices

### Appendix A. Corpus Identification Procedure

The steps in identifying a set of documents (“Corpus”) from which to learn terms are as follows:
1. Via discussion with subject matter experts, identify a set of relevant sources and then subscribe to a content source to them to build an initial corpus. (The platform can crawl the sources on an ongoing basis, or subscribe to RSS or Twitter feeds to create the corpus.)
2. If no relevant sources have been identified, submit the terms generated in Step D (Construct an Initial Approximate Classifier) as search query terms to an internet search engine to search the entire world wide web to identify a “somewhat” relevant set of documents, typically between 4 and 30 pages in length, with the intent of including everything between pamphlets and journal articles, but excluding short news articles and announcements with less substance or very long articles and collections of several articles that are likely to discuss many more topics than the single class under consideration
3. Eliminate duplicate documents.
4. Capture the text of each document, along with any existing metadata (e.g., data, time, title, description (or summary), filepath, existing classifications, named entities).

### Appendix B. Text Processing Procedure

For all documents in the corpus,
1. Run an OCR (“optical character recognition”) program on documents not already in a digitized format.
2. Using a rule-based procedure and a list of exceptional cases, singularize all words in the text.
3. Lower case all words in the text, except acronyms (e.g., words in all capital letters).
4. Replace punctuation (e.g., periods, commas, hyphens, colons, semicolons, question marks, explanation points, long [“em”] dashes) with spaces.
   Appendix C. Construct an Approximate Classifier de novo

If no classifier already exists, build an initial approximate classifier as follows.

For every class in the taxonomy, add terms according to the following rules:
1. Extract the Leaf Node and include it as a term in the initial classifier. For example, for class “Drilling and Completions>Wellbore Design/Construction>Wellbore Integrity/Geomechanics”, the Leaf Node is “Wellbore Integrity/Geomechanics”.
2. If the name contains slash, comma, ampersand, or “and”, extract the nouns, and attach adjectival or noun modifiers to each of the conjuncts separately. Add variations that use ‘and’ and ‘&’ in place of slash or comma. For example,
   “Reservoir Description and Dynamics”→two additional terms: “Reservoir Description”, “Reservoir Dynamics.”
   “Wellbore Integrity/Geomechanics”→three additional terms: “Wellbore Integrity”, “Wellbore Geomechanics”, “Wellbore Integrity and Geomechanics.”
   “Fluid Modeling, Equations of State”→four additional terms: “Fluid Modeling”, “Equations of State”, “Fluid Equations of State”, “Fluid Modeling and Equations of State.”
   There are more than 30 leaf node transformation patterns involving conjunctions. Additional patterns cover disjunctions, prepositions, gerunds, and other linguistic variations. Examples are shown in Appendix H.
3. If the class name is a single word (“singleton”), concatenate it to its parent classes. For example,
   “Transportation>Ground>Rail”→“Ground Rail”, “Transportation Rail”, “Rail Ground”, “Rail Transportation.”

### Appendix D. N-Gram Analysis

For each AGT document that has been processed into a standard form in Step C.
1. Extract every unique n-gram (multi-word sequence) of length 2-4 in each AGT document.
2. Use the Idiom List to ensure that meaningful n-grams are not broken up. Examples from this list include: New York, human resources, managed pressure drilling, vitamin D. The Idiom List may be provided by a subject matter expert for the domain, or generated automatically from external sources, such as textbooks and glossaries for the domain.
3. Capture each remaining n-gram as a candidate term.

### Appendix E. Single Class N-gram Selection Procedure

See FIG. 4. This step removes candidate terms that are unlikely to contribute to successful classification of documents, regardless of the class with which they are associated.

For each candidate n-gram, apply the following rules recursively.
1. If a term equals the name of a class (singularized) or a synonym for the class (e.g., “AI” for the class “Artificial Intelligence”, or “asset management” and “portfolio management” for the class name “Asset and Portfolio Management”), then accept it as a viable candidate and ignore all succeeding rules.
2. Remove terms that are on the Blacklist or match patterns on the Blacklist, including,
   a. Leading and trailing prepositions, definite and indefinite articles, pronouns
   b. Trailing “-ing” words (e.g., boring, depressing)
   c. Trailing numbers or numbers-as-text (e.g., one, two, three)
   d. Trailing transitive verbs
   e. Some leading and trailing adjectives (e.g., actual, advanced, future) and adverbs (e.g., bigger, smaller, greater, lower, largely)
   f. Additional trailing words on a manually-supplied list of frequently used words with little discriminatory power (e.g., versus).

For the remaining n-grams, eliminate any candidate that:
a. is a date
b. contains publication references (e.g., “chapter 2”, “section 3”, “para 2”, “page 10”, “p 1”, “figure 2 1”, “fig 3a”, “table 1”, “appendix a”)
c. contains a publication ID (e.g., “spe 12345”)
d. contains a unit of measure (e.g., “40 ohm resistance”)
e. is a singleton, except for all upper case (acronyms) or words contained in the “gold standard” terms for the taxonomy, such as pathognomonic terms (so-called in the world of diseases) like cardiology and oncology.

Note that this list of filtering criteria may be edited for new taxonomies and subject-matter domains.

For each surviving candidate n-gram, the following statistics are captured.
TF(Term Frequency). the number of occurrences of this term in the AGT set
DF(document frequency). the number of documents in the AGT set in which the term appears
NF(Leaf Node Frequency). the number of classes assigned for the term by the current Approximate Classifier
Common N-grams. the words and phrases in common between the term and the current class name and/or its synonyms
Closeness. The ratio of the number of words in the term that match words in the associated class name, divided by the larger of the number of words in the class name and the number of words in the term. Consider also the variants of the class name, produced by the Linguistic Transformation Procedure (Appendix G). If a term matches more than one variant, select the highest score.
CompTF(comparison term frequency). the sum of the number of occurrences of this term across documents in a comparison set. The comparison set is a random sample of Ncc (e.g., 100) documents from the corpus, a different random sample for each class C.
CompDF(comparison document frequency). the number of documents in the comparison set that contain the term
OtherTF(term frequency in other documents). the sum of the number of occurrences across documents having any classification not equal to the current class.
OtherDF. the number of documents that contain the term across documents having any classification not equal to the current class
TF-INF. a statistic measuring the precision of the term in distinguishing the AGT documents in the current class

$$TF - INF = log ( TF + 1 ) * log ( \frac{{N}_{CC}}{1 + CompDF} )$$

where Ncc is count of comparison documents (analysis parameter)
INF the inverse document frequency of the term, where N is the total number of documents in the corpus. This is a measure of how distinct are the documents classified into the current class from the documents in the corpus.

$$INF = log \frac{N}{DF}$$

Thus INF of a rare term is high, whereas INF of a frequent term is likely to be low.
TF-INFzscore. the number of standard deviations of this term's TF-INFfrom the mean TF-INFfor all terms associated with the current class. The Z-score is calculated by the standard method described in introductory statistics, e.g., https://en. wikipedia.org/wiki/Standard score#Calculation from raw score
OtherTF-INF. the TF-INF score of the term for every other class except the current class, where number of classes is the number of classes in the taxonomy and OtherDF is the number of documents in which the term appears in the AGT sets for every other class except the class in question.

$$OtherTF - INF = log \frac{number of classes * 10}{( 1 + OtherDF )}$$

### Appendix F. Multi-Class N-gram Selection Procedure

See FIG. 4.

For each AGT document, select only terms that pass a two-step filter
1. Exclude terms with Closeness≦N or with NF>5 (absolute thresholding), where N is determined experimentally.
2. Of the remaining, include terms if 3 of 4 conditions (a)-(d) are met:
   a. TF-INFzscore>1.5 (i.e., the frequency of the term within members of the class, relative to its frequency in other classes, is greater than 1.5 standard deviations from the mean TF-INFscore)
   b. TF>2 (i.e., the term appears more than twice in the AGT documents)
   c. DF>1 (i.e., the term appears in more than one of the AGT documents)
   d. NF<3 (i.e., the term is a viable candidate term in only one or two classes)

### Appendix G. Linguistic Transformation Procedure

Refine and expand the list of terms by applying a set of linguistic transformations to each term in the remaining set of terms. Examples are shown below.

1. <verb><noun phrase>→<noun phrase><nominalized verb> and vice versa. For example: “identify fracture”→“fracture identification”
2. <verb><noun phrase>→<nominalized verb> of <noun phrase> and vice versa. For example: “accept the terms”→“acceptance of the terms”
3. -er adjective><noun>→<-ing form of adjective><noun>and vice versa.

For example: desalter unit→desalting unit
4. For terms that end in one of the post-list set of words, (e.g., facility, plant, process, system, unit), add terms for all the other members of the set. Some won't make sense, but the only negative impact will be run-time efficiency.
5. Similarly, for a pre-list of words (e.g., accelerate, acquire, backer of, CEO of, counsel to, director at).
6. Add terms with synonymous words or phrases. For example, for the word “contest”, add terms that include its synonyms, like challenge, match, sport, tournament, game.
7. Create classification rules from the plausible terms by applying expansion rules to the set of terms. Two such rules are to generalize terms that use either numbers or instances of semantic classes.
   To generalize terms using numbers a variety of patterns is used. For example, substitute a regular expression using “\d+” for numbers in terms where a number and a unit of measurement are used with other words either before or after the consecutive number-unit pair. For the class “Football”, “99 yard touchdown” is a candidate term. This is expanded to a regular expression specifying any number of yards: “/\d+ yard touchdown/”.
   To generalize terms using semantic classes the procedure first recognizes that one of the words in the term is a member of a known class and then substitutes the disjunctive class of alternative words for it. For example, in the term “destructive hurricane”, each word is associated with a semantic class, and the term is expanded to the regular expression (using a vertical bar to denote the disjunctive ‘or’): “/(catastrophic\dire\dreadful\calamatous\destructive\ferocious\life threatening\disastrous) (tropical storm\hurricane\typhoon\cyclone\monsoon)/”.

Thus this specific term found in the limited set of documents under consideration, which is considered as good evidence any document is about a wind storm, can be generalized to one rule that covers 8×5=40 different ways of expressing essentially the same thing.
8. Replacement List. In order to reduce redundancies, term variants are replaced by their canonical forms. For example, “oil bitumen” is replaced by “bitumen.” The Replacement List may be provided by a subject matter expert for the domain, or generated automatically from external sources, such as textbooks and glossaries for the domain.

### Appendix H. Linguistic Transformation Pattern Examples

Conjunction patterns
1. Parens—gerund: “Monitoring (Pressure, Temperature, Sonic, Nuclear, Other)”
2. Parens—plain-plural: “Materials Selection (Casing, Fluids, Cement)”
3. Parens-plain-ops: “Downhole Operations (Casing, Cementing, Coring Geosteering Fishing)”
4. Parens—plain: “Pressure Management (MPD, Underbalanced Drilling)”
5. Parens—eg: “Thermal Methods (e.g., Steamflood, Cyclic Steam, THAI, Combustion)”
6. Parens—mid: “Seismic (Four Dimensional) Modeling”
7. Adjective: “Real-Time Data Transmission, Decision-Making”
8. Comma/slash/hyphen: “Torque/Drag Modeling BHA Performance Prediction”
9. Slash—interactions: “Rock/Fluid Interactions”
10. Slash—plain—adj: “Horizontal/Multilateral Wells”
11. Slash—plain—late: “Wellbore Integrity/Geomechanics”
12. Doubles—gerund—mid: “Well Performance Monitoring, Inflow Performance”
13. Doubles—plain: “Performance Measurement Technical Limit”
14. Doubles—gerund—end: “Well Control, Blowout Flow Modeling”
15. Slash-echo: Tata Integration/Oilfield Integration”
16. Slash-peers: “Reservoir Monitoring/Formation Evaluation”
17. Slash-multi: “Oil Sand/Shale/Bitumen”
18. And-related: “Beam and Related Pumping Techniques”
19. And-types-adj: “Single and Multiphase Flow Metering”
20. And-types: “Drilling and Well Control Equipment”
21. And-in: “Fundamental Research in Projects, Facilities and Construction”
22. And-aspects: “Produced Water Use, Discharge and Disposal”
23. And-dbl: “Contingency Planning and Emergency Response”
24. And-other: “Noise, Chemicals and Other Workplace Hazards”
25. And-of: “Future of Energy/Oil and Gas”
26. And-parens-and: “Asphaltenes, Hydrates, Precipitates, Scale, Waxes (Inhibition and Remediation)”
27. And-parens-eg: “Deep Reading and Crosswell Techniques (e.g., Seismic Electromagnetic)”
28. Slash-and: “Global Climate Change/CO2 Capture and Management”
29. And-comma-plain: “Wireline, Coiled Tubing and Telemetry”
30. And-comma-action: “Scale, Sand, Corrosion and Clay Migration Control”
31. And-plain-s: “Drilling Equipment and Operations”
32. And-colon-plural: “Drilling Fluids, Handling Processing and Treatment”
33. And-mgmt: “CO2 Capture and Management”

Non-conjunction patterns
1. Parens—acronym: “Cold Heavy Oil Production (CHOPS)”
2. Of-single: “Siting Assessment of Hazards”
3. Of-slash: “Evaluation of Reservoir Behavior/Performance”
4. Mgmgt-of: “Management of Challenging Reservoirs”
5. Of-plur: “Security of Operating Facilities”
6. Of-swap: “Reservoir Engineering of Subsurface Storage”
7. Adj-term: “Global Climate Change”
8. In: “Flow Assurance in Subsea Systems”
9. Integration: “Integrating HSE into the Business”

### Appendix I. Regular Expression Pattern Examples

A regular expression (“regex”) defines a search pattern and a replacement pattern. The precise representation is immaterial, but in the following description, a vertical bar separating terms within parentheses represents “OR”. Thus, the pattern “[[1-9]]” appearing in a rule can be replaced by the list of alternative names of the numbers one through nine. Each list is not strictly a collection of synonyms, but represents alternative terms that may be used within a classification rule associated with classes within the taxonomy under consideration.

The collection of patterns will grow and be refined over time.

| Pattern | List |
|---|---|
| [[1-9]] | (one\|two\|three\|four\|five\|six\|seven\|eight\|nine) |
| [[10-20]] | (ten\|eleven\|twelve\|thirteen\|fourteen\|fifteen\|sixteen\|seventeen\|eighteen\| |
| | nineteen\|twenty) |
| [[2-10]] | (two\|three\|four\|five\|six\|seven\|eight\|nine\|ten) |
| [[agreement]] | (agreement\|pact\|treaty\|accord\|contract\|negotiated settlement) |
| [[airplane]] | (plane\|airplane\|ailiner\|jet aircraft\|helicopter\|passenger plane) |
| [[algorithm]] | (algorithm\|process\|procedure\|approach) |
| [[big]] | (big\|biggest\|huge\|largel\|largest) |
| [[brutal]] | (brutal\|atrocious\|barbarous\|bloodthirsty\|bloody\|brutish\|cold- |
| | blooded\|cruel\|deadly\|deathly\|ferocious\|furious\|fierce\|grim\|harsh\|murderous\| |
| | ruthless\|savage\|vicious) |
| [[catastrophic]] | (catastrophic\|dire\|dreadful\|calamatous\|destructive\|ferocious\|life-threatening\| |
| | disastrous) |
| [[certification]] | (certification\|permit\|compliance\|license) |
| [[children]] | (children\|newborn\|toddler\|preschooler\|kid\|young children\|teenager\|teen\| |
| | adolescent) |
| [[cooked condition]] | (cooked\|baked\|roasted\|fried\|grilled\|barbequed\|braised\|broiled\|boiled\| |
| | hard boiled\|deep fried\|poached\|pickled\|sauteed\|toasted\|steamed\|blanched) |
| [[cooking prep verb]] | (carve\|slice\|fillet\|garnish\|glaze\|salt\|sweeten\|serve) |
| [[cooking verb]] | (cook\|bake\|roast\|fry\|grill\|braise\|broil\|baste\|boil\|hard boi\|steam\|simmer\| |
| | parboil\|deep fry\|poach\|pickle\|saute\|toast\|steam\|blanche) |
| [[corp]] | (Corp.\|corporation\|Co.\|company\|Inc.\|Incorporated\|LLC\|Ltd.) |
| [[crazed]] | (crazed\|demonic\|bestial\|demented\|devilish\|satanic\|diabolical\|feral\|heartless\| |
| | hellish\|infernal\|inhuman\|rabid\|rapacious\|unrelenting) |
| [[create]] | (will\|have\|is\|are)? (create\|created\|creating\|cause\|caused\|causing) |
| [[direction]] | (north\|south\|east\|west\|northbound\|southbound\|eastbound\|westbound\|northeast\| |
| | northwest\|southeast\|southwest) |
| [[disaster]] | (disaster\|calamity\|incident\|catastrophe) |
| [[dish]] | (appetizer\|sandwich\|casserole\|soup\|salad\|stew\|broth\|chili\|gravy\|kabobs\|nuggets\| |
| | pasta\|pie\|pot pie\|roast\|stir-fry\|stroganoff\|tenderloin\|tacos) |
| [[finding]] | (finding\|result\|conclusion) |
| [[flow]] | (flow\|rate\|volume\|pressure) |
| [[fruit]] | (apple\|pear\|plum\|blueberry\|raspberry\|strawberry\|orange\|lemon\|lime) |
| [[gauge]] | (gauge\|measurement device\|meter\|sensing device\|sensor\|indicator) |
| [[gunman]] | (gunman\|gunmen\|kiler\|shooter\|gang\|gang member) |
| [[historic]] | (historic\|record- |
| | breaking\|catastrophic\|extreme\|severe\|unprecedented\|continuing) |
| [[hits]] | (hits\|roars into\|slams\|batters\|crashes into\|rips through\|devastates) |
| [[huge]] | (huge\|very large\|giant\|massive\|major\|big\|clolossal\|gigantic\|mammoth) |
| [[institution]] | (school\|hospital\|nursing home\|library\|university\|college\|highschool\|grade |
| | school\| |
| | elementary school\|primary school\|preschool) |
| [[intellectual property]] | (IP\|intellectual property)copyright\|patent\|trademark) |
| [[jail]] | (jail\|police custody\|prison) |
| [[jobless]] | (jobless\|unemployed\|without work\|out of work) |
| [[kill]] | (kill\|killed\|murder\|murdered\|fatally injure\|fatally shot\|fatally stabs\|fatally |
| | wound) |
| [[liquid measure]] | (cups\|pints\|quarts\|gallons\|c\.\|pt\.lqt\.lqts\.\|gal\|g\.\|keg\|barrel\|bbl\.) |
| [[method]] | (method\|technique\|technology\|tool\|methodology) |
| [[month]] | (January\|February\|March\|April\|May\|June\|July\|August\|September\|October\| |
| | November\|December) |
| [[natural habitat]] | (arctic tundra\|beaches\|boreal forest\|coastal wetland\|coral reef\|fish habitat\| |
| | open ocean\|seashore\|tropical rainforest\|desert\|dunes) |
| [[oil commodity]] | (crude\|oil\|WTI\|Brent\|Dated Brent) |
| [[person]] | (person\|man\|woman\|men\|women\|boy\|girl\|child\|children\|people) |
| [[problem]] | (problem\|challenge\|difficulty\|issue) |
| [[rationale]] | (rationale\|justification\|explanation\|reason) |
| [[savage]] | (savage\|atrocous\|barbarous\|bloodthirsty\|bloody\|brutal\|brutish\|cold- |
| | blooded\|ferocious\|furious\|fierce\|harsh) |
| [[size comparison]] | (three\|four\|five\|six\|seven\|eight\|nine\|ten) times (as (big\|large\|long\|heavy) |
| | as\|(bigger\|larger\|longer\|heavier) than) |
| [[skill]] | (skill\|competency\|ability\|expertise\|specialization\|knowledge\|specialty\| |
| | understanding\|in-depth knowledge) |
| [[standard]] | (standard\|code\|regulation) |
| [[tropical storm]] | (tropical storm\|hurricane\|typhoon\|cyclone\|monsoon) |
| [[unusual]] | (unusual\|abnormal\|excessive\|unexplained\|mysterious\|strange\|out of the |
| | ordinary\|weird) |
| [[weekday]] | (Monday\|Tuesday\|Wednesday\|Thursday\|Friday\|Saturday\|Sunday) |
| [[worst ever]] | (worst ever\|deadliest\|most destructive\|apocalyptic\|worst in history) |

What is claimed:

1. A method of classifying a set of unstructured text documents for a subject matter without using pre-classified training examples, comprising:
a) identifying a taxonomy of classes having class names for the subject matter;
b) searching at least some of said set of text documents with one or more of said class names to construct rules for an approximate classifier;
c) classifying at least some of the set of text documents into said classes using said approximate classifier and producing a confidence factor for each document classified;
d) generating a list of plausible terms for a number of said classes based at least in part on said confidence factor;
e) eliminating plausible terms from the list for each class based at least in part on a set of elimination criteria;
f) modifying said approximate classifier for each class based on said elimination criteria; and
g) repeating steps c)-f) until a stopping condition is met.

2. The method of claim 1, said taxonomy comprising a hierarchy of classes for said subject matter.

3. The method of claim 1, each class in said taxonomy comprising one or more words or phrases found in one or more documents related to said subject matter.

4. The method of claim 1, said constructing an approximate classifier comprising extracting a leaf node for inclusion as a term in said approximate classifier.

5. The method of claim 1, said constructing an approximate classifier comprising, for a single word class name, concatenate the word to its parent class.

6. The method of claim 1, said constructing an approximate classifier comprising applying a set of linguistic transformations to one or more terms in said approximate classifier.

7. The method of claim 1, said generating a list of plausible terms step comprising an N-gram analysis.

8. The method of claim 1, said generating a list of plausible terms step comprising a linguistic transformation procedure.

9. The method of claim 1, said eliminating plausible terms step comprising a single class N-gram selection procedure.

10. The method of claim 1, said eliminating plausible terms step comprising a multi-class N-gram selection procedure.

11. The method of claim 1, said elimination criteria comprising applying a single class N-gram selection procedure to remove candidate terms unlikely to contribute to successful classification of documents.

12. The method of claim 1, said selection criteria comprising applying a multi-class N-gram selection procedure based on statistics indicating terms will contribute to successful classification of documents.

13. The method of claim 1, said stopping condition comprising one or more of the following are met—
a) the difference in the number of plausible terms resulting from repeating step g) is smaller than a pre-set threshold,
b) the same number or more terms are being added in repeating step g) and removed in another repeating step g), or
c) an approximate classifier has been created for every class in the taxonomy.

14. A system of classifying a set of unstructured textual documents, without using pre-classified training examples, comprising:
computer memory loaded with one or more class names and one or more computer processors programmed to expand the class name into a set of words and phrases;
computer memory loaded with a set of unstructured text documents and said one or more computer processors programmed to search the set of unstructured text documents to construct an approximate classifier;
said one or more computer processors programmed to classify at least some of the set of text documents into said classes using said approximate classifier and producing a confidence factor for each document classified;
said one or more computer processors programmed to generate a list of plausible terms for a number of said classes based at least in part on said confidence factor;
said one or more computer processors programmed to eliminate plausible terms from the list for each class based at least in part on an elimination criteria and to modify said approximate classifier for each class based on said elimination criteria; and
said one or more computer processors programmed to iteratively classify text documents, generate plausible terms and modify the approximate classifier until a stopping criteria is met.

15. The system of claim 15, said list of plausible terms being generated by an N-gram analysis.

16. The system of claim 15, said elimination criteria comprising said one or more processors programmed to apply a single class N-gram selection procedure to remove candidate terms unlikely to contribute to successful classification of documents.

17. The system of claim 15, said selection criteria comprising said one or more processors programmed to apply a multi-class N-gram selection procedure based on statistics indicating terms will contribute to successful classification of documents.

18. The system of claim 15, said stopping criteria for stopping iteratively classifying of said one or more processors comprising one or more of determining if—
the difference in the number of plausible terms resulting from iteration is smaller than a pre-set threshold,
the same number or more terms are being added during iteration and removed in another iteration, or
an approximate classifier has been created for every class.

19. A system for classifying a set of unstructured text documents into a plurality of classes without using pre-classified training examples, comprising:
a processor; and
a storage device coupled to the processor and configurable for storing instructions, which when executed by the processor cause the processor to:
use a class name into a set of semantically related terms,
search at least some of said set of unstructured text documents with one or more of said terms to construct an approximate classifier,
recursively apply the approximate classifier to evaluate its performance, and modify the approximate classifier using an elimination criteria until a stopping condition is met.

20. The system of claim 19, further comprising instructions to apply a stopping condition comprising one or more of the following:
a) the difference in the number of terms resulting from recursively applying the approximate classifier is smaller than a pre-set threshold,
b) the same number or more terms are being added in recursively applying the approximate classifier and removed in recursively applying the approximate classifier, or
c) an approximate classifier has been created for every class.
